(19) United States
(12) Patent Application Publication
(10) Pub. No.: US 2026/0203298 A1
(43) Pub. Date: Jul. 16, 2026

(54) SYSTEM AND METHOD FOR REDUCING NODE OVERLAPS AND EDGE CROSSINGS IN A LARGE GRAPH DATA

(71) Applicant: International Institute of Information Technology, Hyderabad, Hyderabad (IN)

(72) Inventors: Kamalakar Karlapalem, Hyderabad (IN); Garima Jindal, Hyderabad (IN)

(21) Appl. No.: 19/447,367

(22) Filed: Jan. 13, 2026

(30) Foreign Application Priority Data
Jan. 13, 2025 (IN) 202541002772

(51) Int. Cl. G06F 16/26

(52) U.S. Cl. CPC G06F 16/26

(57) ABSTRACT

Embodiments herein provide a method for reducing node overlaps and edge crossings in a large graph data by arranging one or more communities and one or more nodes of the large graph data and visually represent the large graph data according to a user selection. The method includes (i) identifying the one or more communities in the large graph data, (ii) determining one or more centrality parameters and one or more community attribute parameters for ranking the nodes and the communities, (iii) arranging the one or more ranked nodes in a first ranked community sequentially from left to right along a horizonal axis of a layout environment, and (iv) reversing placement direction of the one or more ranked nodes on reaching right end of the horizontal axis and continuing arranging the one or more ranked nodes from the right to the left along the horizonal axis, creating a snake-like structure.

### BACKGROUND

### Technical Field

The embodiments herein generally relate to a data visualization, more particularly a system and a method for reducing node overlaps and edge crossings in a large graph data by arranging one or more communities and one or more nodes of the large graph data to visually represent the large graph data according to a user selection and visually identify important communities.

### Description of the Related Art

Data visualization is the graphical representation of information. The graphical representation may be charts, graphs, and maps. Visualizing large datasets in a graph has long posed challenges, particularly in networks containing thousands of nodes and communities. The communities represent groups of nodes and edges. The nodes within the communities are more densely connected than nodes outside the group.

The node-link diagrams are a common approach for visualizing graphs by representing nodes as points and edges as lines for connecting these points. The traditional approaches of node-link diagrams often struggle with visual clutter, caused by overlapping nodes and crossing edges, which hampers the effective interpretation of complex networks. As the graph size increases, the visual clutter becomes more complex. This complicates the understanding of relationships between nodes and communities.

One of the key challenges in analysing large networks is ranking or identifying important communities within the graph. In large graphs, hundreds of such communities may exist, making it difficult to focus on the most significant ones. This complexity highlights the need for methods that are used by users to prioritize communities for further analysis based on properties such as size, edgedensity, and number of inter-community connections.

While traditional visualizations may generate an overview of the network, they often do not allow users to easily explore how communities are connected or the density of internal connections within a community.

The existing visualization system is for generating a spiral visualization. The spiral visualization is generated by arranging nodes of a community in a spiral pattern. However, this method faces significant drawbacks, particularly in handling large numbers of communities. The spiral arrangement struggles to scale effectively as an increase of different number of communities leads to spiral overlaps. This limitation results in a lack of clarity regarding community ranking and relationships, making it challenging to interpret the node and community properties of complex networks effectively. Additionally, the spiral layout results in dense node placement near the center of the spiral and increasingly sparse node placement toward the outer regions. For large communities, this uneven distribution leads to excessive whitespace in outer spiral regions and visual congestion near the center, further reducing clarity. Consequently, the spiral visualization becomes unsuitable for effectively representing large communities and large-scale networks, limiting its applicability in complex graph analysis.

Another existing system is for generating a matrix visualization. In matrix visualization, nodes are ordered along rows and columns of matrix to visualize edges between the pair of nodes. However, it is not an intuitive format for most users and is more suited to experts in the field. Additionally, the matrix visualization requires a significant amount of space as the graph size increases, which makes them inefficient for very large networks.

The spiral visualization, node-link diagrams, and matrix visualizations face significant challenges when applied to large graphs. They either fail to scale effectively, obscure important community and node ranking insights, or are too complex for general users.

However, there remains a need to address the aforementioned technical drawbacks.

### SUMMARY

In view of the foregoing, an embodiment herein provides method for reducing node overlaps and edge crossings in a large graph data by arranging one or more communities and one or more nodes of the large graph data to visually represent the large graph data according to a user selection and visually identify important communities. The method includes identifying the one or more communities in the large graph data by subdividing the one or more nodes in the large graph data into the one or more communities using a community detection algorithm. The large graph data is received from a user device associated with a user, and the large graph data comprises the one or more nodes and one or more edges connecting the one or more nodes. The method includes determining one or more centrality parameters for each node, wherein the one or more centrality parameters comprises at least one of (i) a degree centrality, (ii) a betweenness centrality, (iii) a closeness centrality, or (iv) an eigen centrality. The method includes determining one or more community attribute parameters for each community, wherein the one or more community attribute parameters comprises at least one of (i) a community size, (ii) an edge density, or (iii) a number of community connection. The method includes ranking the one or more nodes of each community in a descending order by enabling the user to select at least one centrality parameter from the one or more centrality parameters displayed on a user interface of the user device. The method includes ranking the one or more communities in a descending order by selecting at least one community attribute parameter from the one or more community attribute parameters displayed on the user interface of the user device. The method includes arranging the one or more ranked nodes in a first ranked community sequentially from left to right along a horizonal axis of a layout environment. The first ranked community is placed at the topmost position along a vertical axis of the layout environment. The method includes reversing placement direction of the one or more ranked nodes on reaching right end of the horizontal axis of the layout environment and continuing arranging the one or more ranked nodes from the right to the left along the horizonal axis of the layout environment in a linear wrap-around manner, creating a snake-like structure. The method includes visually representing the large graph data according to the user selection to reduce the node overlaps and the edge crossings by arranging the one or more ranked nodes continuously until the one or more ranked nodes of the first ranked community are placed, and a small separation gap is left to visually separate the first ranked community from a second ranked community.

In an embodiment, the method includes arranging the one or more ranked nodes of the second ranked community in the same linear wrap-around manner along the horizonal axis of the layout environment, wherein the second ranked community is placed after the separation gap from the first ranked community along the vertical axis of the layout environment, and the separation gap between the first ranked community and the second ranked community distinguishes the one or more nodes that belong to different communities.

In an embodiment, the method includes arranging each subsequent ranked community one after another from top to bottom of the vertical axis of the layout environment, with each community being placed after the separation gap from a previous community.

In an embodiment, the one or more communities are labelled along the vertical axis of the layout environment to interpret community ranking.

In an embodiment, the method includes applying colors to the one or more ranked nodes that are arranged in the linear wrap-around manner based on the one or more centrality parameters or the edge density of the community to which the node belongs, as selected by the user through the user device.

In an embodiment, the method includes initializing the layout environment with the vertical axis to arrange the one or more ranked communities and the horizontal axis to arrange the one or more ranked nodes within each community.

In one aspect, a system for reducing node overlaps and edge crossings in a large graph data by arranging one or more communities and one or more nodes of the large graph data to visually represent the large graph data according to a user selection and visually identify important communities is provided. The server that is communicatively connected to a user device through a network. The server includes a memory that includes a set of instructions. The server further includes a processor that is configured to retrieve and execute the set of instructions from the memory. The processor is configured to identify the one or more communities in the large graph data by subdividing the one or more nodes in the large graph data into the one or more communities using a community detection algorithm. The large graph data is received from a user device associated with a user, and the large graph data includes the one or more nodes and one or more edges connecting the one or more nodes. The processor is configured to determine one or more centrality parameters for each node. The one or more centrality parameters includes at least one of (i) a degree centrality, (ii) a betweenness centrality, (iii) a closeness centrality, or (iv) an eigen centrality. The processor is configured to determine one or more community attribute parameters for each community, wherein the one or more community attribute parameters comprises at least one of (i) a community size, (ii) an edge density, or (iii) a number of community connection. The processor is configured to rank the one or more nodes of each community in a descending order by enabling the user to select at least one centrality parameter from the one or more centrality parameters displayed on a user interface of the user device. The processor is configured to rank the one or more communities in a descending order by selecting at least one community attribute parameter from the one or more community attribute parameters displayed on the user interface of the user device. The processor is configured to arrange the one or more ranked nodes in a first ranked community sequentially from left to right along a horizonal axis of a layout environment, wherein the first ranked community is placed at the topmost position along a vertical axis of the layout environment. The processor is configured reverse placement direction of the one or more ranked nodes on reaching right end of the horizontal axis of the layout environment and continuing arranging the one or more ranked nodes from right to left along the horizonal axis of the layout environment in a linear wrap-around manner, creating a snake-like structure. The processor is configured to visually represent the large graph data according to the user selection to reduce the node overlaps and the edge crossings by arranging the one or more ranked nodes continuously until the one or more ranked nodes of the first ranked community are placed, and a small separation gap is left to visually separate the first ranked community from a second ranked community.

In an embodiment, the processor is configured to arrange the one or more ranked nodes of the second ranked community in the same linear wrap-around manner along the horizonal axis of the layout environment. The second ranked community is placed after the separation gap from the first ranked community along the vertical axis of the layout environment, and the separation gap between the first ranked community and the second ranked community distinguishes the one or more nodes that belong to different communities.

In an embodiment, the processor is configured to arrange each subsequent ranked community one after another from top to bottom of the vertical axis of the layout environment, with each community being placed after the separation gap from a previous community.

In another aspect, one or more non-transitory computer-readable storage mediums storing one or more sequences of instructions, which when executed by one or more processors, cause a method for reducing node overlaps and edge crossings in a large graph data by arranging one or more communities and one or more nodes of the large graph data to visually represent the large graph data according to a user selection and visually identify important communities. The method includes identifying the one or more communities in the large graph data by subdividing the one or more nodes in the large graph data into the one or more communities using a community detection algorithm. The large graph data is received from a user device associated with a user, and the large graph data comprises the one or more nodes and one or more edges connecting the one or more nodes. The method includes determining one or more centrality parameters for each node, wherein the one or more centrality parameters comprises at least one of (i) a degree centrality, (ii) a betweenness centrality, (iii) a closeness centrality, or (iv) an eigen centrality. The method includes determining one or more community attribute parameters for each community, wherein the one or more community attribute parameters comprises at least one of (i) a community size, (ii) an edge density, or (iii) a number of community connection. The method includes ranking the one or more nodes of each community in a descending order by enabling the user to select at least one centrality parameter from the one or more centrality parameters displayed on a user interface of the user device. The method includes ranking the one or more communities in a descending order by selecting at least one community attribute parameter from the one or more community attribute parameters displayed on the user interface of the user device. The method includes arranging the one or more ranked nodes in a first ranked community sequentially from left to right along a horizonal axis of a layout environment. The first ranked community is placed at the topmost position along a vertical axis of the layout environment. The method includes reversing placement direction of the one or more ranked nodes on reaching right end of the horizontal axis of the layout environment and continuing arranging the one or more ranked nodes from the right to the left along the horizonal axis of the layout environment in a linear wrap-around manner, creating a snake-like structure. The method includes visually representing the large graph data according to the user selection to reduce the node overlaps and the edge crossings by arranging the one or more ranked nodes continuously until the one or more ranked nodes of the first ranked community are placed, and a small separation gap is left to visually separate the first ranked community from a second ranked community.

### BRIEF DESCRIPTION OF THE DRAWINGS

The embodiments herein will be better understood from the following detailed description with reference to the drawings, in which:

FIG. 1 illustrates a block diagram of a system for visually representing a large graph data by arranging communities and nodes based on a user selection according to an embodiment herein;

FIG. 2 illustrates a block diagram of a server of FIG. 1 according to an embodiment herein;

FIGS. 3A-3B illustrate an exemplary user interface for visualizing and arranging nodes and communities within a layout environment according to some embodiments herein;

FIG. 4A illustrates an exemplary user interface view of arranging communities based on a community size of each community within Facebook dataset according to some embodiments herein;

FIG. 4B illustrates an exemplary user interface view of arranging communities based on an edge density of each community within Facebook dataset according to some embodiments herein;

FIG. 4C illustrates an exemplary user interface view of arranging communities based on a number of community connections within Facebook dataset according to some embodiments herein;

FIG. 5A illustrates an exemplary user interface view that displays community connections and node connections according to some embodiments herein;

FIG. 5B illustrates an exemplary user interface view 5 that displays visualization of node color coding based on degree centrality according to some embodiments herein;

FIG. 6 illustrates an exemplary user interface view that displays a time taken by an existing spiral visualization method and the system to complete network analysis task according to some embodiments herein;

FIGS. 7A and 7B are flowcharts that illustrate a method for visually representing a large graph data by arranging communities and nodes based on a user selection according to some embodiments herein; and

FIG. 8 is a schematic diagram of the computer architecture in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The examples used herein are intended merely to facilitate an understanding of ways in which the embodiments herein. The examples used herein may be practiced and to further enable those of skill in the art to practice the embodiments herein. Accordingly, the examples should be constructed as limiting the scope of the embodiments herein.

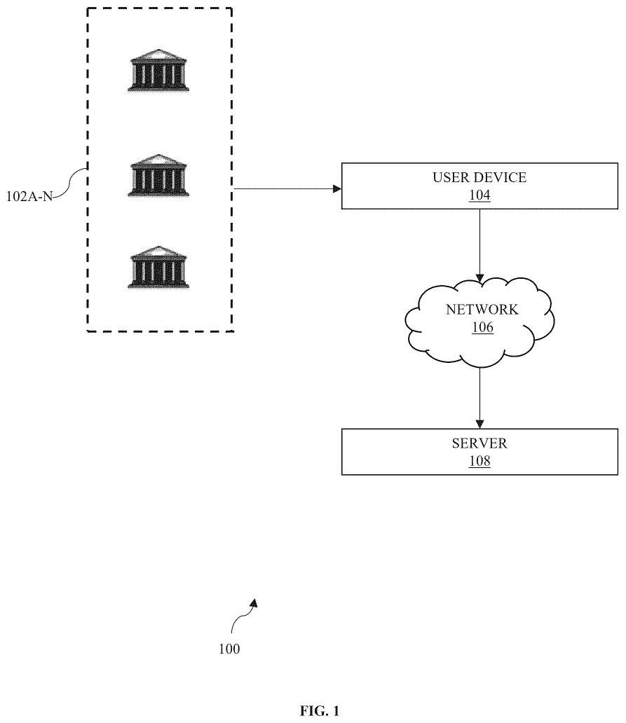

As mentioned, there remains a need for a system and a method for reducing node overlaps and edge crossings in a large graph data by arranging one or more communities and one or more nodes of the large graph data to visually represent the large graph data according to a user selection and identify important communities in the large graph data. Referring now to the drawings, and more particularly, FIGS. 1 through 8, where similar reference characters denote corresponding features consistently throughout the figure's, preferred embodiments are shown.

FIG. 1 illustrates a block diagram of a system 100 for visually representing a large graph data by arranging communities and nodes based on a user selection according to an embodiment herein. The system 100 includes the one or more entities or users 102A-N, a user device 104, a network 106, and a server 108. The user device 104 may be, but it is not limited to, a laptop, a smartphone, a tablet, a smart glass, or a personal computer. The server 108 is communicatively connected to the user device 104 associated with an entity or user 102 through the network 106 to receive a large graph data. The large graph data may be social graph data, knowledge graph data, network traffic graph data, geospatial graph data, hierarchical graph data, transactional graph data, or biological graph data. In some embodiments, the network 106 is a wired. The network 106 is a wireless network. The network 106 is a combination of the wired network and the wireless network. The network 106 is an Internet. The large graph data provided by the user 102 includes one or more nodes and one or more edges connecting the one or more nodes.

The server 108 identifies one or more communities in the graph data using a community detection algorithm. The community detection algorithm processes the graph data and subdivides the one or more nodes in the graph data into one or more communities. Each community includes one or more nodes and one or more edges. The community detection algorithm may be a Louvain algorithm, or a Leiden algorithm. Louvain algorithm identifies communities by maximizing network modularity through an efficient, multi-level optimization process, making it suitable for large-scale networks. Leiden algorithm is an improved version of the Louvain algorithm that guarantees well-connected communities and faster convergence by refining the modularity optimization process.

The server 108 determines one or more centrality parameters for each node. The centrality parameters are used to identify a most important nodes within each community among the one or more nodes. The one or more centrality parameters include at least one of (i) a degree centrality, (ii) a betweenness centrality, (iii) a closeness centrality, or (iv) an eigen centrality.

The degree of centrality means a degree of each node or number of connections each node has. This indicates how many nodes are connected with a particular node or how popular a node is are there within each community or network. The degree of a node is determined by the number of adjacent nodes connected to the node. The betweenness centrality is a measure of the intermediary role of each node between different communities. This component calculates the betweenness centrality for each node. The betweenness centrality measures the extent to which the node acts as a bridge between other nodes by calculating the number of shortest paths passing through it. The betweenness centrality of the node is determined by considering all pairs of nodes in the community and counting the number of shortest paths that pass through the node of interest. The higher number of such paths, (i.e., higher number of the node's) betweenness centrality.

The one or more nodes with high betweenness centrality are significant in connecting different parts of the community and have significant control over the flow of information. Identifying the one or more nodes with high betweenness centrality may be utilized by the user 102 in understanding bottlenecks within a network.

The closeness centrality calculates the closeness centrality of each node, reflecting how close the node is to all other nodes in the network. The closeness centrality indicates how near the node is to all other nodes by calculating the inverse of the sum of the shortest path distances from that node to all other nodes. The one or more nodes with higher closeness centrality scores have shorter average distances to all other nodes.

The Eigen centrality calculates the eigen centrality of each node, indicating whether the node is connected to other important or popular nodes in the network. The basic idea is that the importance of a node depends on its neighbour's importance. Therefore, the node's popularity or importance corresponds to the principal eigenvector of the network.

The server 108 determines one or more community attribute parameters for each community. The community attribute parameters identify a most important communities among the one or more communities. The one or more community attribute parameters include at least one of (i) a community size, (ii) an edge density, or (iii) a number of community connections. The community size refers to a number of nodes contained within the community. The edge density represents the ratio of the number of actual edges to the total number of possible edges within the community. The edge density indicates how strongly the nodes are connected within the community. For example, a higher edge density signifies a more densely connected to the community.

The number of community connections mean the number of other communities to which a specific community is connected. The number of community connections measure the extent of interaction or links between a community and other communities in the graph data or the network. The two communities are considered and connected if a subset of the one or more nodes in the community is linked to the subset of the one or more nodes in another community.

The server 108 ranks the one or more nodes in each community based on the at least one parameter of the centrality parameters. The server 108 enables the user to select the at least one parameter from the centrality parameters. The one or more nodes within each community are ordered in descending order according to the selected parameter. The server 108 positions the one or more ranked nodes within each community in a linear wrap-around manner. The linear wrap-around manner/layout is a visualization technique that arranges the one or more nodes in a linear sequence along the horizontal axis while allowing the nodes to wrap around from one end of the layout environment to the other allowing linear visualization of the large graph data. The linear-wrap around layout displays each community compactly, making it easier to visualize node centrality of the large graph data due to continuous placement of ordered nodes

The server 108 ranks the one or more communities based on at least one parameter of the one or more community attribute parameters. The server 108 enables the user 102A to select the at least one parameter from the community attribute parameters. Each community is ordered in descending order according to the selected parameter. The server 108 positions the one or more ranked communities sequentially on a vertical axis. The server 108 arranges the one or more communities one after another from top to bottom along the vertical axis to distinguish the one or more nodes belonging to different communities. This helps in identifying important communities based on selected parameter.

The server 108 ranks the one or more communities in descending order based on their size and arrange them along the vertical axis from top to bottom if the user 102 selects the community size parameter. This helps the one or more users 102A-N to easily focus on large communities for further analysis. The server 108 ranks the one or more communities in descending order based on how densely the nodes are connected within each community and arranges them along the vertical axis from top to bottom if the user 102 selects the edge density parameter. This helps one or more users 102A-N to quickly identify and focus on communities with high edge density, which may indicate more cohesive or tightly-knit groups within the network. The server 108 ranks the one or more communities in descending order based on their connectivity to other communities and arranges them along the vertical axis if the user 102 selects the number of community connections parameter. This helps the one or more users 102A-N to identify and focus on communities that act as bridges or are central to the network.

The server 108 applies a color code to each node. The server 108 enables the user 102A to select color coding through the user device 104. The server 108 allows the user 102A to select the color code for one or more nodes based on the edge density, the degree centrality, the closeness centrality, the betweenness centrality, and the eigenvector centrality.

The ranked one or more nodes in a first-ranked community are placed sequentially from left to right starting at the topmost position of the vertical axis of a layout/visualization environment. The server 108 initializes a layout environment that includes a vertical axis to arrange communities and a horizontal axis for node placement within each community. When the end of the horizontal space is reached, the placement direction reverses, continuing from right to left, creating a snake-like structure. This process continues until the one or more nodes of the ranked community are placed. After the one or more nodes of the ranked community are placed, a small gap is left to visually separate the ranked community from the next. This separation ensures that users can easily distinguish the one or more nodes that belong to different communities. The edge crossings in the large graph data are reduced as the edges are shown or drawn only on demand or when the user 102 hovers over a node.

The ordered nodes of the next community in the ranking are placed in the same linear wrap-around manner, starting after the separation gap from the previous community. The process repeats for each subsequent community, with each community node placed after a separation gap from the previous community nodes. The communities are labeled along the vertical axis to facilitate comprehension of community ranking and to further lookup operations or community identification. The community node is integrated along the vertical axis for each community, placed beside its community label. The one or more 102A-N users can interact with these community nodes to comprehend community connections.

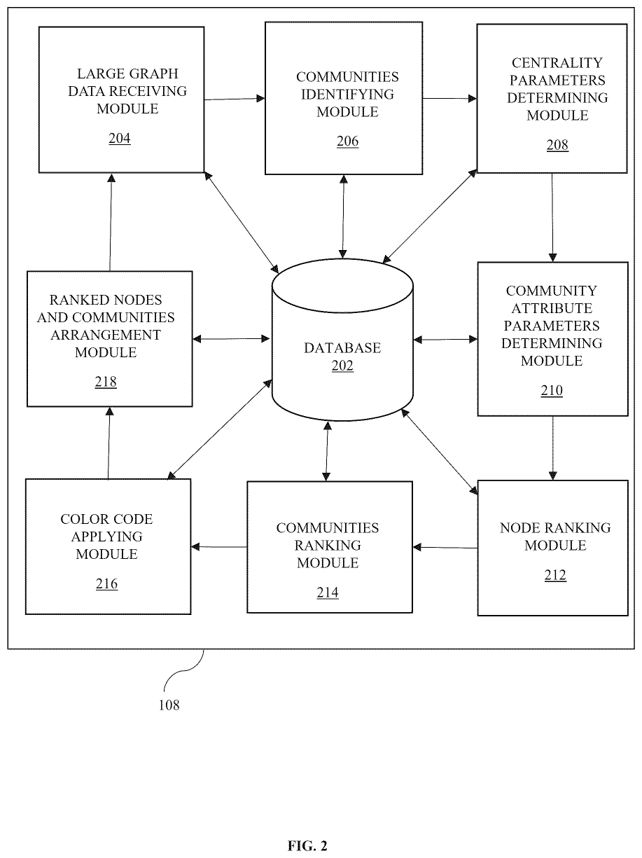

FIG. 2 illustrates a block diagram of the server 108 of FIG. 1 according to some embodiments herein. The server 108 includes a large graph data receiving module 204, communities identifying module 206, centrality parameters determining module 208, community attribute parameters determining module 210, a node ranking module 212, communities ranking module 214, a color code applying module 216, a ranked nodes and communities arrangement module 218, a database 202.

The large graph data receiving module 204 receives the graph data of the one or more users 102A-N from the user device 104 through the network 106. The received graph data includes the one or more nodes and one or more edges connecting the one or more nodes. The communities identifying module 206 identifies the one or more communities in the graph data of the one or more users 102A-N by processing the graph data of the one or more users 102A-N using the community detection algorithm. The community detection algorithm subdivides the one or more nodes in the graph data of the one or more users 102A-N into the one or more communities. The one or more communities include the one or more nodes.

The centrality parameters determining module 208 determines one or more centrality parameters includes at least one of (i) a degree centrality, (ii) a betweenness centrality, (iii) a closeness centrality, or (iv) an eigen centrality. The degree centrality calculates the degree of each node that indicates how many nodes are connected with a node or how popular the node is within a network. The betweenness centrality is a measure of the intermediary role of each node between different communities. This component calculates the betweenness centrality for each node. The closeness centrality calculates the closeness centrality of each node, reflecting how close the node is to all other nodes in the network. The closeness centrality indicates how near the node is to all other nodes by calculating the inverse of a distance from that node to the others. The Eigen centrality calculates the eigen centrality of each node, indicating whether the node is connected to other important or popular nodes in the network. The basic idea is that the importance of a node depends on its neighbour's importance.

The community attribute parameters determining module 210 determines the one or more community attribute parameters for each community. The one or more community attribute parameters includes at least one of (i) a community size, (ii) an edge density, or (iii) a number of community connections. The community size represents the number of nodes in each community. The edge density represents the ratio of the number of actual edges to the total number of possible edges within the community. The edge density indicates how strongly the nodes are connected within the community. For example, a higher edge density signifies a more densely connected to the community.

The number of community connections mean the number of other communities to which a specific community is connected. The number of community connections measure the extent of interaction or links between a community and other communities in the graph data or the network.

The node ranking module 212 ranks the one or more nodes in descending order in each community based on at least one of the one or more centrality parameters. The at least one centrality parameter is selected by the one or more users 102A-N through the user device 104. The communities ranking module 214 ranks the one or more communities in descending order based on at least one of the one or more community attribute parameters. The one community attribute parameter is selected by the one or more users 102A-N through the user device 104. The communities ranking module 214 arranges the ranked communities one after the other along the vertical axis of the layout environment based on the selected community attribute parameters. The color code applying module 216 applies a color code to each node based on the one or more centrality parameters or edge density that is selected by the user 102 through the user device 104.

The ranked nodes and communities arrangement module 218 visually represents the large graph data by assigning positions to each node within each community. The positioning of the one or more nodes is arranged based on the ranked one or more nodes. The ranked nodes and communities arrangement module arranges the one or more nodes of each community in a linear wrap-around layout.

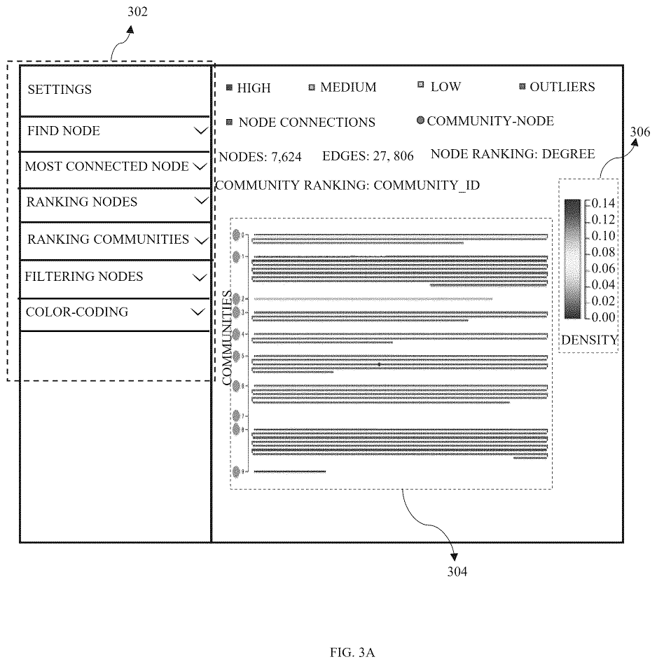

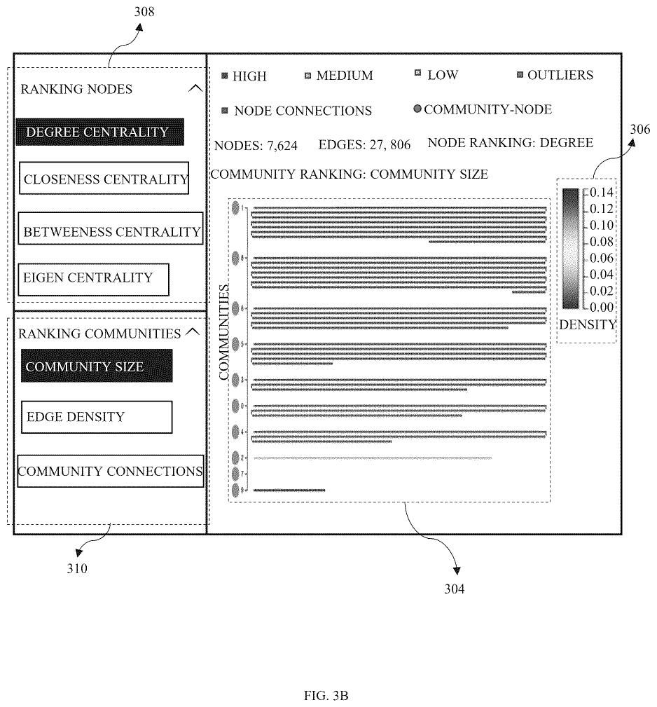

FIGS. 3A-3B illustrate an exemplary user interface for visualizing and arranging nodes and communities within a layout environment according to some embodiments herein. FIG. 3A illustrates a user interface displaying a layout environment 304 and an associated task pane. The task pane includes a menu bar 302 providing multiple user-selectable options, including but not limited to settings, find node, most connected node, ranking nodes, ranking communities, filtering nodes and color-coding. Based on one or more options selected by the user through the menu bar 302, nodes and communities are ranked and visually arranged within the layout environment 304. The ranked nodes and communities are arranged in a linear wrap-around manner where the communities are arranged along the vertical axis of the layout environment 304 and the nodes within the communities are arranged along the horizontal axis of the layout environment 304. FIG. 3A further showing the number of nodes and number of edges, where node ranking is based on a default degree centrality parameter, and community ranking is based on a default community id. In the FIG. 3A, communities are indexed from community 0 through community 9. The task pane further includes a color-coding bar 306, which is a vertically oriented bar displayed adjacent to the layout environment 304. The color-coding bar 306 visually represents a selected parameter using a color scale, such as a transition from low to high intensity. By default, the color-coding bar may represent density, and the user may modify the color-coding selection via the color-coding option in the menu bar 302. Based on user selection, the color-coding bar 306 is generated and applied to the nodes in the layout environment 304. In some embodiments, the color categories include high, medium, low, outliers, node connections, and community-node, thereby enabling visual differentiation of nodes based on selected criteria.

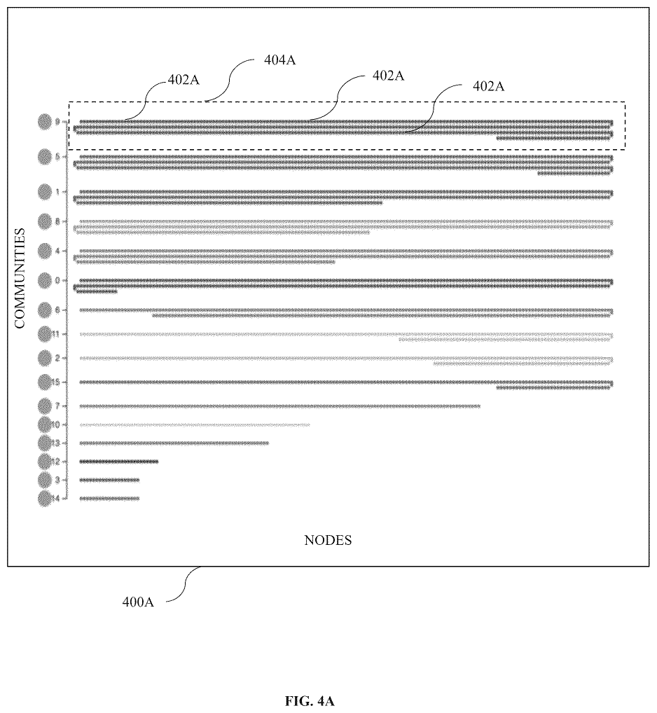

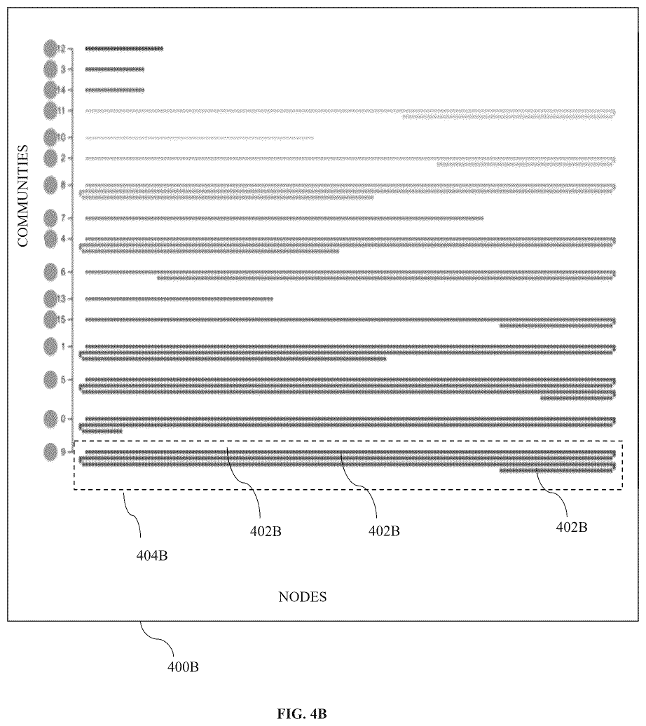

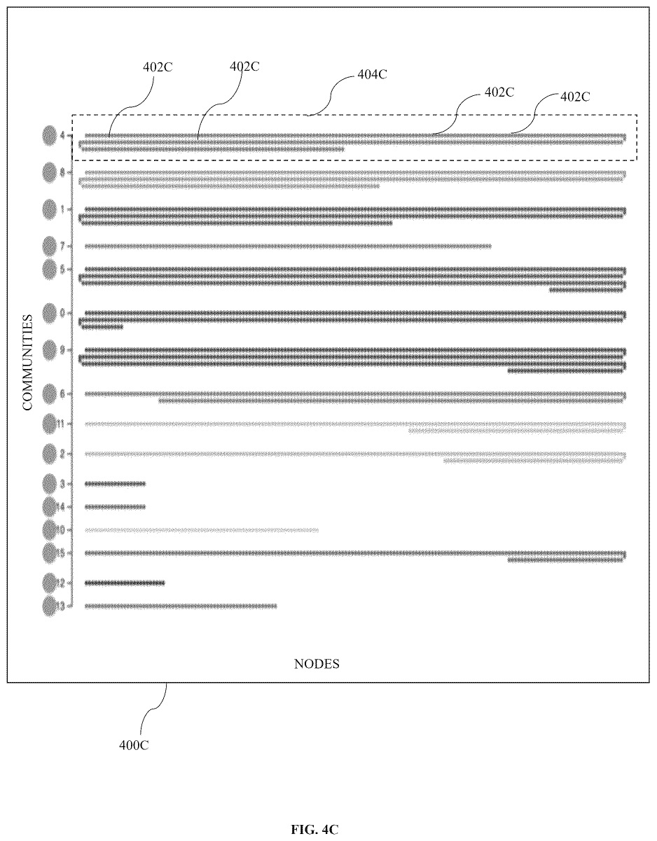

FIG. 3B illustrates the menu bar 302 when the ranking nodes option 308 and the ranking communities option 310 are selected by the user. The ranking nodes option 308 presents a list of centrality parameters, including degree centrality, closeness centrality, betweenness centrality, and eigen centrality. The ranking communities option 310 presents community attribute parameters such as community size, edge density, and number of community connections. In the FIG. 3B, the user selects degree centrality for ranking nodes and community size for ranking communities. The selected parameters are visually highlighted in a black box to indicate active selection. Based on these selections, the nodes and communities are ranked in descending order and arranged within the layout environment 304 in a linear wrap around manner. The color-coding bar 306 continues to reflect the selected parameter (for example, density), even if not explicitly shown in FIG. 3B. FIGS. 3A-3B demonstrate a user interface that enables a user to interactively select parameter, rank and arrange nodes and communities, and visually analyze nodes and communities within a layout environment 304. FIG. 4A illustrates an exemplary user interface view 400A of arranging communities based on a community size of each community within Facebook dataset according to some embodiments herein. The user interface view 400A depicts one or more communities arranged by their size and arranged vertically, from top to bottom along the vertical axis of the layout environment based on the community size of the Facebook dataset. The size of community is depicted by length of liner wrap around layout. For example, community 9 is the largest, with the longest wrap around layout, while community 14 is the smallest. The user selects the community size attribute from options such as the community size, an edge density, or number of connections with other communities. The user interface view 400A community IDs associated with the one or more communities as labels in a vertical axis for the users to identify the relevant communities. Each community 404A with arranged nodes 402A, and each node being represented as circular point arranged along the horizontal axis of the layout environment, placed next to the labels on the vertical axis.

FIG. 4B illustrates an exemplary user interface view 400B of arranging communities based on an edge density of each community within Facebook dataset according to some embodiments herein. The user interface view 400B depicts arranged nodes in each community positioned sequentially in a linear wrap-around layout at 402B. The user interface view 400B depicts density of one or more communities arranged vertically in descending order from top to bottom along the vertical axis of the layout environment based on the edge density of the Facebook dataset. The red color represents high edge density. The yellow color represents medium edge density. The blue color represents low edge density. The user selects the edge density attribute from options such as the community size, the edge density, or the number of connections with other communities. The user interface view 400B displays community IDs associated with the one or more communities as labels in a vertical axis for the users to identify the relevant communities. Each community 404B with arranged nodes 402B, and each node being represented as circular point arranged along the horizontal axis of the layout environment, placed next to the labels on the vertical axis. The user interface view 400B displays communities are arranged vertically by edge density. For example, community 12, with the highest density, is at the top, while community 9, the largest but less dense, is at the bottom.

FIG. 4C illustrates an exemplary user interface view 400C of arranging communities based on a number of community connections within Facebook dataset according to some embodiments herein. The user interface view 400C depicts one or more communities arranged vertically in descending order from top to bottom along the vertical axis of the layout environment based on the number of connections with other communities within the Facebook dataset. The user selects the number of connections from other community attributes from options such as the community size, the edge density, or the number of connections with other communities. The user interface view 400C displays community IDs associated with the one or more communities as labels in a vertical axis for the user to identify the relevant communities. Each community 404C with arranged nodes 402C, and each node being represented as circular point arranged along the horizontal axis of the layout environment, placed next to the labels on the vertical axis.

The user interface views of visualization dashboard 400A, 400B, and 400C utilize the Facebook dataset, which includes 16 communities or communities arranged along the vertical axis of the layout environment. The nodes within each community are arranged in descending order based on the determined centrality parameters and placed linearly, adhering to Gestalt's principle of continuity. The length of the linear wrap-around visually represents the size of each community as shown in FIG. 4A, with community 9 being the largest and community 14 the smallest. The user can order communities based on the edge density along the vertical axis, enabling them to identify community with higher edge density based on their vertical position. For example, in FIG. 4B, the communities are arranged by the edge density, with community 12 having the highest edge density and community 9 having highest edge density, the largest community, exhibiting the lowest edge density.

In FIG. 4B, the user interface view 400B that displays visualization of node color coding based on the edge density. Each node is colored to represent its edge density value, with blue indicating low density, orange representing medium density, and red representing high density. The user interface view 400B displays a legend on the right side of the visualization dynamically updates to reflect the selected edge density values, providing users with an intuitive understanding of the density distribution within the network. The user interface view 400B provides an option to color-code nodes based on edge density. The user interface view 400B displays enable communities to be arranged vertically based on the edge density, allowing users to identify the communities with higher edge density at the top.

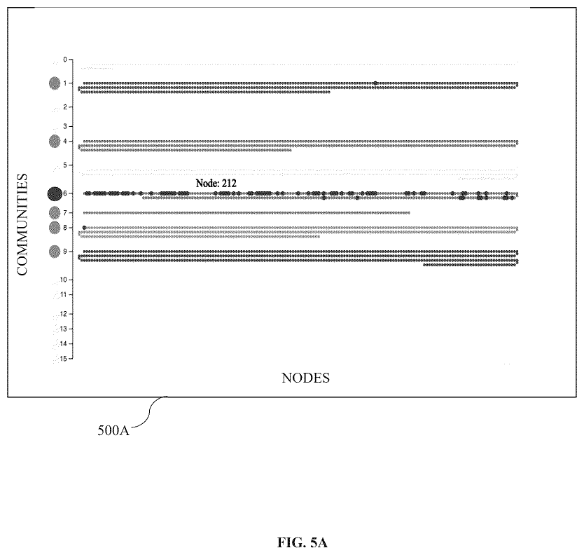

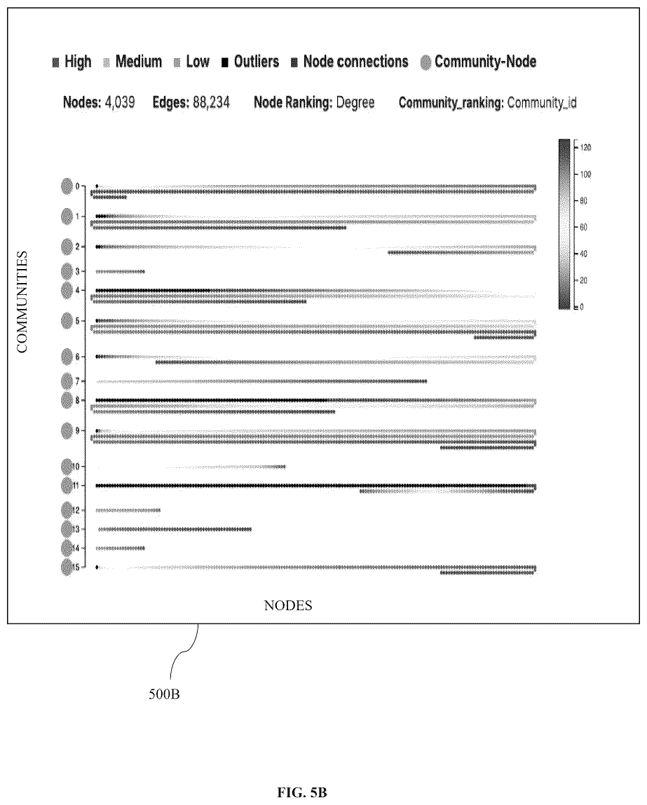

FIG. 5A illustrates an exemplary user interface view 500A that displays community connections and node connections according to some embodiments herein. As shown in FIG. 5A, when a user 102 hovers over a node in Community, it is seen to be highlighting its direct connections to other nodes by visually increasing the size or changing the color of the adjacent nodes, making it easy to see how the node is linked to other nodes within and across communities. Since the edges are not explicitly drawn to show connections, visual clutter is avoided. This reduces edge overlaps as adjacent nodes are highlighted only on demand or based on the user interaction with the nodes. The user interface view 500A enables users to explore specific relationships both within the same community (intra-community) and across different communities (inter-community). As shown in FIG. 5A, hovering over community 6 highlights all community connections by highlighting community and nodes.

FIG. 5B illustrates an exemplary user interface view 500B that displays visualization of node color coding based on degree centrality according to some embodiments herein. The user interface view 500B displays color-coded according to degree centrality values. The nodes are colored to reflect their degree centrality scores, with blue representing low centrality, orange indicating medium centrality, and red signifying high centrality. The user interface view 500B displays the nodes that fall outside the interquartile range (IQR), in black, identifying them as outliers with significantly high degree values. This helps in visualizing degree distribution in each community. The visual layout adheres to Gestalt's principle of continuity.

The right side of the user interface view 500B displays a color code bar being dynamically updated to reflect the selected centrality parameter. The user interface view 500B displays the nodes with high degree centrality scores are identified as outliers and are highlighted in black. As shown in FIG. 5B, the user interface view 500B nodes in Community 11 are colored black, indicating a higher number of highly connected nodes within the community. This visualization allows users to identify and analyze the distribution of centrality values within and across communities.

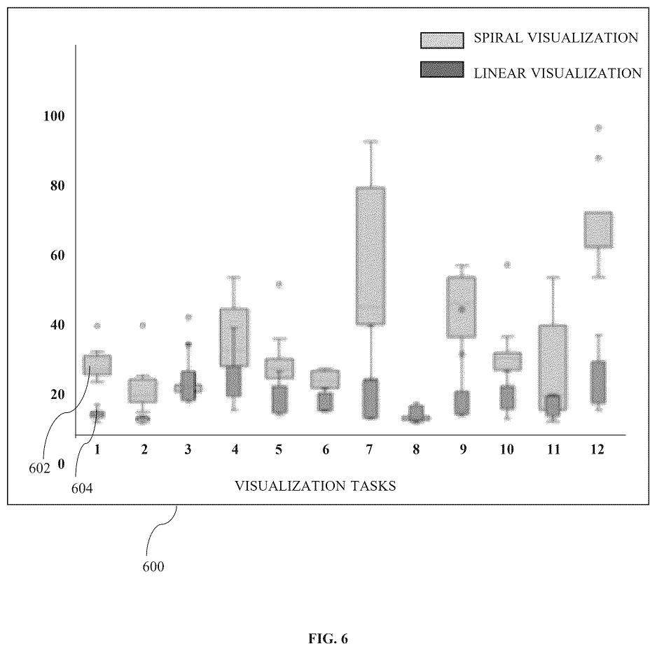

FIG. 6 illustrates an exemplary user interface view 600 that displays a time taken by an existing spiral visualization method and the system 100 to complete network analysis task according to some embodiments herein. The user interface view displays network visualization task on an X-axis and time on a Y-axis. The user interface view 600 displays a comparative analysis of the system 100 that is the linear visualization versus the spiral visualization method in enhancing user comprehension of various network characteristics. The time taken by the spiral visualization method for each task is denoted by 602A. The time taken by the system 100 for each task is denoted by 604. The user interface view shows that the time taken by the system 100 is less than the time taken by the spiral visualization method.

For example, participants are initially given a demonstration of both visualization techniques, followed by a series of tasks executed on a 15-inch Retina Display. A total of 21 distinct tasks were created, and participants interacted with the system 100 via a mousepad, while their task completion times were accurately recorded. Additionally, the participants provided confidence and perceived difficulty ratings using a Likert scale. Each participation session lasted approximately 75 to 90 minutes.

The participants stated a clear preference for the system 100 when the task (3-6) of understanding community sizes. The system 100 effectively arranged and displayed communities by size, facilitating the comprehension of size rankings and the identification of the largest and smallest communities. The spiral visualization method confused, particularly in distinguishing smaller communities, as its spiral structure did not adequately support size comparisons.

During the tasks of 7-10, the system 100 presents edge density through easily distinguishable colors and the vertical axis that allows users to rank communities based on density. The spiral visualization method required participants to compare subtle color variations within spirals, leading to increased time consumption and reduced accuracy, particularly for smaller communities.

In tracing connections of Task 11, the participants preferred the system 100 due to its highlighting feature, which minimized visual clutter and enhanced the efficiency of connection tracing. The spiral visualization method represents connections through edges between spirals, is evaluated for generating visual noise, complicating the comprehension of node relationships. During the tasks of 12-17, the system 100 facilitated ease of identification and ranking of communities based on the number of connections. However, the spiral visualization method demonstrated an advantage in depicting the strength of connections through edge thickness during tasks assessing connection strength (Task 18). When evaluating node centrality (Tasks 19-21), the spiral visualization method outperformed system 100 in speed and confidence, enabling the participants to inspect central nodes closely.

Table: 1 displays an assessment of different tasks related to network community analysis. The tasks are organized into categories, and each task is evaluated based on two parameters: Confidence and Easiness. These parameters are measured on a 4-point scale, with corresponding numbers indicating participant responses.

The table: 1 shows the percentage of participants, their confidence levels, and perceived easiness while performing each task, alongside the overall accuracy (i.e., the percentage of participants who answered correctly) for the system 100. The corresponding results of spiral visualization are given within brackets [ ].

TABLE 1

| | | Confidence (%) | | | | | | | Easiness (%) | | | | | Accuracy | |
|---|---|---|---|---|---|---|---|---|---|---|---|---|---|---|---|
| | Name | 1 | | 2 | | 3 | | 4 | 1 | 2 | 3 | | 4 | (%) | |
| | Indentify and Count | | | | | | | | | | | | | | |
| | Communities | | | | | | | | | | | | | | |
| Task 1 | Count Communities | 100 | [20] | 0 | [80] | 0 | | 0 | 88.8 [20] | 11.1 [70] | 0 | [10] | 0 | 100 | [88.8] |
| Task 2 | Find Community | 100 | [60] | 0 | [40] | 0 | | 0 | 88.8 [30] | 11.1 [50] | 0 | [20] | 0 | 100 | [100] |
| | Size of the Community | | | | | | | | | | | | | | |
| Task 3 | Largest Community | 88.8 | [20] | 11.1 | [80] | 0 | | 0 | 77.7 [10] | 22.2 [80] | 0 | [10] | 0 | 100 | [100] |
| Task 4 | Smallest Community | 66.6 | [30] | 33.3 | [60] | 0 | [10] | 0 | 66.6 [30] | 33.3 [60] | 0 | [10] | 0 | 88.8 | [88.8] |
| Task 5 | Size Ranking | 100 | [10] | 0 | [70] | 0 | [20] | 0 | 88.8 [10] | 11.1 [60] | 0 | [30] | 0 | 100 | [55.5] |
| Task 6 | Compare Community Size | 100 | [80] | 0 | [20] | 0 | | 0 | 88.8 [70] | 11.1 [20] | 0 | [10] | 0 | 100 | [100] |
| | Edge-density of the | | | | | | | | | | | | | | |
| | Community | | | | | | | | | | | | | | |
| Task 7 | Densest Community | 100 | [30] | 0 | [40] | 0 | [30] | 0 | 77.7 [30] | 22.2 [40] | 0 | [30] | 0 | 100 | [44.4] |
| Task 8 | Low Density Communities | 77.7 | [70] | 22.2 | [30] | 0 | | 0 | 77.7 [70] | 22.2 [20] | 0 | [10] | 0 | 100 | [100] |
| Task 9 | Density Ranking | 88.8 | | 11.1 | [40] | 0 | [60] | 0 | 88.8 | 11.1 [40] | 0 | [40] | 0 [20] | 88.8 | [44.4] |
| Task 10 | Compare Density | 100 | [50] | 0 | [50] | 0 | | 0 | 88.8 [40] | 11.1 [50] | 0 | [10] | 0 | 100 | [88.9] |
| | Node to Node Connections | | | | | | | | | | | | | | |
| Task 11 | Node Connections | 88.8 | [60] | 11.1 | [40] | 0 | | 0 | 66.6 [60] | 33.3 [30] | 0 | [10] | 0 | 100 | [88.9] |
| | Community to Community | | | | | | | | | | | | | | |
| | Connections | | | | | | | | | | | | | | |
| Task 12 | Most Connected | 100 | | 0 | [80] | 0 | [20] | 0 | 66.6 | 33.3 [60] | 0 | [40] | 0 | 100 | [66.6] |
| | Community | | | | | | | | | | | | | | |
| Task 13 | Least Connected | 77.7 | [80] | 11.1 | [20] | 11.1 | | 0 | 77.7 [80] | 11.1 [20] | 11.1 | | 0 | 100 | [100] |
| | Community | | | | | | | | | | | | | | |
| Task 14 | Community Connection | 77.7 | [70] | 11.1 | [20] | 11.1 | [10] | 0 | 66.6 [30] | 33.3 [50] | 0 | [20] | 0 | 88.8 | [77.7] |
| | Raking | | | | | | | | | | | | | | |
| Task 15 | Find Community | 88.8 | [80] | 11.1 | [20] | 0 | | 0 | 77.7 [80] | 22.2 [20] | 0 | | 0 | 100 | [100] |
| | Connection | | | | | | | | | | | | | | |
| Task 16 | Compare Community | 77.7 | [70] | 22.2 | [30] | 0 | | 0 | 88.8 [10] | 11.1 [90] | 0 | | 0 | 100 | [100] |
| | Connections | | | | | | | | | | | | | | |
| Task 17 | Count Adjacent | 77.7 | [70] | 22.2 | [30] | 0 | | 0 | 88.8 [60] | 11.1 [40] | 0 | | 0 | 100 | [88.8] |
| | Communities | | | | | | | | | | | | | | |
| Task 18 | Strength of Community | 44.4 | [70] | 22.2 | [30] | 33.3 | | 0 | 11.1 [70] | 11.1 [20] | 44.4 | [10] | 33.3 | 55.5 | [77.7] |
| | Connection | | | | | | | | | | | | | | |
| | Node Centrality | | | | | | | | | | | | | | |
| Task 19 | Most Central Node | 33.3 | [70] | 44.4 | [30] | 22.2 | | 0 | 33.3 [40] | 44.4 [50] | 22.2 | [10] | 0 | 100 | [100] |
| Task 20 | Least Central Node | 33.3 | [50] | 44.4 | [40] | 22.2 | [10] | 0 | 22.2 [40] | 55.5 [40] | 22.2 | [10] | 0 [10] | 100 | [100] |

| | | | | | | | | | | | | | | |
|---|---|---|---|---|---|---|---|---|---|---|---|---|---|---|
| Task 21 | Centrality Distribution | 66.6 | [50] | 33.3 | [50] | 0 | 0 | 55.5 [50] | 44.4 [40] | 0 | [10] | 0 | 100 | [88.8] |

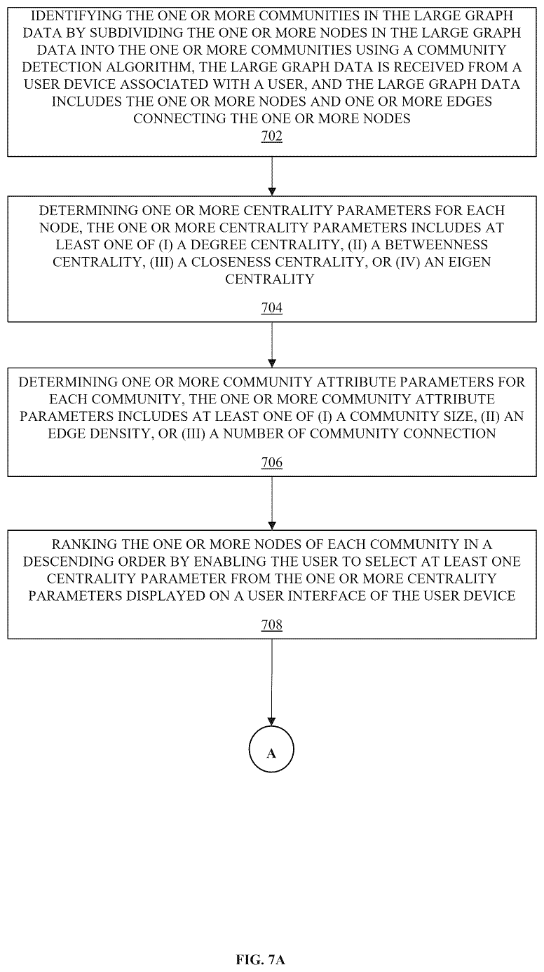

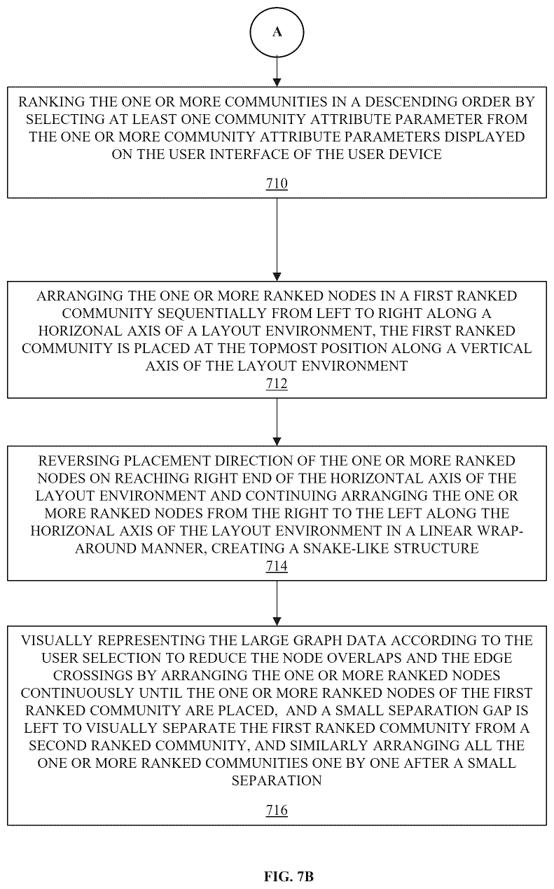

FIGS. 7A and 7B are flowcharts that illustrate a method for visually representing a large graph data by arranging communities and nodes based on a user selection according to some embodiments herein. At step 702, the method includes identifying the one or more communities in the large graph data by subdividing the one or more nodes in the large graph data into the one or more communities using a community detection algorithm, the large graph data is received from a user device associated with a user, and the large graph data includes the one or more nodes and one or more edges connecting the one or more nodes.

At step 704, the method includes determining one or more centrality parameters for each node, the one or more centrality parameters includes at least one of (i) a degree centrality, (ii) a betweenness centrality, (iii) a closeness centrality, or (iv) an eigen centrality.

At step 706, the method includes determining one or more community attribute parameters for each community, the one or more community attribute parameters includes at least one of (i) a community size, (ii) an edge density, or (iii) a number of community connection.

At step 708, the method includes ranking the one or more nodes of each community in a descending order by enabling the user to select at least one centrality parameter from the one or more centrality parameters displayed on a user interface of the user device.

At step 710, the method includes ranking the one or more communities in a descending order by selecting at least one community attribute parameter from the one or more community attribute parameters displayed on the user interface of the user device.

At step 712, the method includes arranging the one or more ranked nodes in a first ranked community sequentially from left to right along a horizonal axis of a layout environment, the first ranked community is placed at the topmost position along a vertical axis of the layout environment.

At step 714, the method includes reversing placement direction of the one or more ranked nodes on reaching right end of the horizontal axis of the layout environment and continuing arranging the one or more ranked nodes from the right to the left along the horizonal axis of the layout environment, creating a snake-like structure.

At step 716, the method includes visually representing the large graph data according to the user selection to reduce the node overlaps and the edge crossings by arranging the one or more ranked nodes continuously until the one or more ranked nodes of the first ranked community are placed, and a small separation gap is left to visually separate the first ranked community from a second ranked community, and similarly arranging all the one or more ranked communities one by one after a small separation.

The method reduces edge overlap by showing edges between the nodes by highlighting the connected nodes only on demand that is when the user 102 hovers over a node as shown in FIG. 5A.

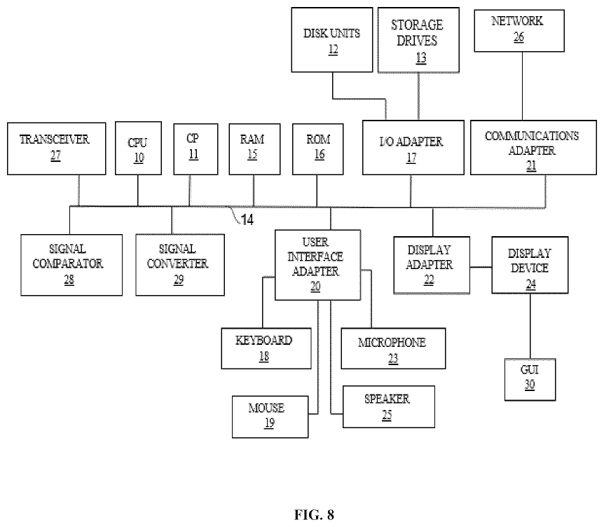

A representative hardware environment for practicing the embodiments herein is depicted in FIG. 8, with reference to FIGS. 1 through 7A and 7B. This schematic drawing illustrates a hardware configuration of an end user communicating device/server 108 in accordance with the embodiments herein. The system 100 comprises at least one processor or central processing unit (CPU) 10. The CPUs 10 are interconnected via system bus 12 to various devices such as a random-access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system 100. The system 100 can read the inventive instructions on the program storage devices and follow these instructions to execute the methodology of the embodiments herein.

The system 100 further includes a user interface adapter 19 that connects a keyboard 15, mouse 17, speaker 24, microphone 22, and/or other user interface devices such as a touch screen device (not shown) or remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The system 100 visualizes the network at a scale. The primary advantage of this method is its ability to efficiently represent a large number of nodes and edges within a linear wrap-around layout. By highlighting relationships through color-coded adjacent nodes on hover, instead of explicitly drawing connections, the approach enhances scalability while minimizing visual clutter. This method displays communities sequentially along a vertical axis, enabling scalable representation and easy comparison of multiple communities. Additionally, this method effectively ranks communities and nodes by leveraging calculated attributes and centrality scores, which are visually represented through an intuitive linear arrangement. The integration of a user interface and visualization component provides a streamlined and interactive method for exploring complex networks, facilitating clearer data interpretation and comparison of node and community significance.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A processor-implemented method for reducing node overlaps and edge crossings in a large graph data by arranging one or more communities and one or more nodes of the large graph data to visually represent the large graph data according to a user selection and visually identify important communities, wherein the method comprises:
identifying the one or more communities in the large graph data by subdividing the one or more nodes in the large graph data into the one or more communities using a community detection algorithm, wherein the large graph data is received from a user device associated with a user, and the large graph data comprises the one or more nodes and one or more edges connecting the one or more nodes;
determining one or more centrality parameters for each node, wherein the one or more centrality parameters comprises at least one of (i) a degree centrality, (ii) a betweenness centrality, (iii) a closeness centrality, or (iv) an eigen centrality;
determining one or more community attribute parameters for each community, wherein the one or more community attribute parameters comprises at least one of (i) a community size, (ii) an edge density, or (iii) a number of community connection;
ranking the one or more nodes of each community in a descending order by enabling the user to select at least one centrality parameter from the one or more centrality parameters displayed on a user interface of the user device;
ranking the one or more communities in a descending order by selecting at least one community attribute parameter from the one or more community attribute parameters displayed on the user interface of the user device;
arranging the one or more ranked nodes in a first ranked community sequentially from left to right along a horizonal axis of a layout environment, wherein the first ranked community is placed at the topmost position along a vertical axis of the layout environment;
reversing placement direction of the one or more ranked nodes on reaching right end of the horizontal axis of the layout environment and continuing arranging the one or more ranked nodes from the right to the left along the horizonal axis of the layout environment in a linear wrap-around manner, creating a snake-like structure; and
visually representing the large graph data according to the user selection to reduce the node overlaps and the edge crossings by arranging the one or more ranked nodes continuously until the one or more ranked nodes of the first ranked community are placed, and a small separation gap is left to visually separate the first ranked community from a second ranked community.

2. The processor-implemented method as claimed in claim 1, wherein the method comprises arranging the one or more ranked nodes of the second ranked community in the same linear wrap-around manner along the horizonal axis of the layout environment, wherein the second ranked community is placed after the separation gap from the first ranked community along the vertical axis of the layout environment, and the separation gap between the first ranked community and the second ranked community distinguishes the one or more nodes that belong to different communities.

3. The processor-implemented method of claim 2, wherein the method comprises arranging each subsequent ranked community one after another from top to bottom of the vertical axis of the layout environment, with each community being placed after the separation gap from a previous community.

4. The processor-implemented method of claim 1, wherein the one or more communities are labelled along the vertical axis of the layout environment to interpret community ranking.

5. The processor-implemented method of claim 1, wherein the method comprises applying colors to the one or more ranked nodes that are arranged in the linear wrap-around manner based on the one or more centrality parameters or the edge density of the community to which the node belongs, as selected by the user through the user device.

6. The processor-implemented method of claim 1, wherein the method comprises initializing the layout environment with the vertical axis to arrange the one or more ranked communities and the horizontal axis to arrange the one or more ranked nodes within each community.

7. A system for reducing node overlaps and edge crossings in a large graph data by arranging one or more communities and one or more nodes of the large graph data to visually represent the large graph data according to a user selection and visually identify important communities, wherein the system comprises:
a server that is communicatively connected to a user device through a network, wherein the server comprises:
a memory comprising a set of instructions;
a processor that is configured to retrieve and execute the set of instructions from the memory and is configured to:
identify the one or more communities in the large graph data by subdividing the one or more nodes in the large graph data into the one or more communities using a community detection algorithm, wherein the large graph data is received from a user device associated with a user, and the large graph data comprises the one or more nodes and one or more edges connecting the one or more nodes;
determine one or more centrality parameters for each node, wherein the one or more centrality parameters comprises at least one of (i) a degree centrality, (ii) a betweenness centrality, (iii) a closeness centrality, or (iv) an eigen centrality;
determine one or more community attribute parameters for each community, wherein the one or more community attribute parameters comprises at least one of (i) a community size, (ii) an edge density, or (iii) a number of community connection;
rank the one or more nodes of each community in a descending order by enabling the user to select at least one centrality parameter from the one or more centrality parameters displayed on a user interface of the user device;
rank the one or more communities in a descending order by selecting at least one community attribute parameter from the one or more community attribute parameters displayed on the user interface of the user device;
arrange the one or more ranked nodes in a first ranked community sequentially from left to right along a horizonal axis of a layout environment, wherein the first ranked community is placed at the topmost position along a vertical axis of the layout environment;
reverse placement direction of the one or more ranked nodes on reaching right end of the horizontal axis of the layout environment and continuing arranging the one or more ranked nodes from right to left along the horizonal axis of the layout environment in a linear wrap-around manner, creating a snake-like structure; and
visually represent the large graph data according to the user selection to reduce the node overlaps and the edge crossings by arranging the one or more ranked nodes continuously until the one or more ranked nodes of the first ranked community are placed, and a small separation gap is left to visually separate the first ranked community from a second ranked community.

8. The system of claim 7, wherein the processor is configured to arrange the one or more ranked nodes of the second ranked community in the same linear wrap-around manner along the horizonal axis of the layout environment, wherein the second ranked community is placed after the separation gap from the first ranked community along the vertical axis of the layout environment, and the separation gap between the first ranked community and the second ranked community distinguishes the one or more nodes that belong to different communities.

9. The system of claim 8, wherein the processor is configured to arrange each subsequent ranked community one after another from top to bottom of the vertical axis of the layout environment, with each community being placed after the separation gap from a previous community.

10. One or more non-transitory computer-readable storage mediums storing one or more sequences of instructions, which when executed by one or more processors, cause a method for reducing node overlaps and edge crossings in a large graph data by arranging one or more communities and one or more nodes of the large graph data to visually represent the large graph data according to a user selection and visually identify important communities, wherein the method comprises:
identifying the one or more communities in the large graph data by subdividing the one or more nodes in the large graph data into the one or more communities using a community detection algorithm, wherein the large graph data is received from a user device associated with a user, and the large graph data comprises the one or more nodes and one or more edges connecting the one or more nodes;
determining one or more centrality parameters for each node, wherein the one or more centrality parameters comprises at least one of (i) a degree centrality, (ii) a betweenness centrality, (iii) a closeness centrality, or (iv) an eigen centrality;
determining one or more community attribute parameters for each community, wherein the one or more community attribute parameters comprises at least one of (i) a community size, (ii) an edge density, or (iii) a number of community connection;
ranking the one or more nodes of each community in a descending order by enabling the user to select at least one centrality parameter from the one or more centrality parameters displayed on a user interface of the user device;
ranking the one or more communities in a descending order by selecting at least one community attribute parameter from the one or more community attribute parameters displayed on the user interface of the user device;
arranging the one or more ranked nodes in a first ranked community sequentially from left to right along a horizonal axis of a layout environment, wherein the first ranked community is placed at the topmost position along a vertical axis of the layout environment;
reversing placement direction of the one or more ranked nodes on reaching right end of the horizontal axis of the layout environment and continuing arranging the one or more ranked nodes from the right to the left along the horizonal axis of the layout environment in a linear wrap-around manner, creating a snake-like structure; and
visually representing the large graph data according to the user selection to reduce the node overlaps and the edge crossings by arranging the one or more ranked nodes continuously until the one or more ranked nodes of the first ranked community are placed, and a small separation gap is left to visually separate the first ranked community from a second ranked community.
